(19) United States
(12) Patent Application Publication
(10) Pub. No.: US 2011/0181243 A1
(43) Pub. Date: Jul. 28, 2011

(54) BATTERY CHARGER FOR A BATTERY PACK HOUSING RECHARGEABLE BATTERIES

(76) Inventors: Nobuhiro MABUCHI, Sumoto-shi (JP); Masahiro Sugita, Sumoto-shi (JP)

(21) Appl. No.: 13/013,132

(22) Filed: Jan. 25, 2011

(30) Foreign Application Priority Data
Jan. 28, 2010 (JP) 2010-017499

(51) Int. Cl. H02J 7/00

(52) U.S. Cl. 320/112

(57) ABSTRACT

The battery charger charges a battery pack housing rechargeable batteries by attaching the battery pack 30 in a detachable manner on the battery charger. The battery charger is provided with a case 1 having an attachment section 2 where a battery pack 30 is attached in a detachable manner, and a plurality of connecting terminals 3 disposed in an exposed manner in the attachment section 2 to connect with external terminals 33 on the battery pack 30. The plurality of connecting terminals 3 is disposed in a plurality of rows. The connecting terminals 3 are provided with positive and negative charging terminals 4 disposed on both sides, and non-charging terminals 5 disposed between the charging terminals 4. Further, the non-charging terminals 5 are disposed in a manner projecting outward further than the charging terminals 4 on both sides.

### BACKGROUND OF THE INVENTION

1. Field of the Invention

The present invention relates primarily to a battery charger for charging a battery pack that attaches in a detachable manner and supplies power to electrically driven machinery such as an electric power tool.

2. Description of the Related Art

Cordless electrically driven machinery such as cordless power tools can be used conveniently at the work site by attaching (in a detachable manner) a battery pack housing batteries that can be charged. Further, the battery pack can be used repeatedly by detaching it from the electrically driven machinery and recharging. Here, a battery pack, which houses batteries run down in charge capacity, is charged by attaching it to a battery charger.

Battery chargers to charge these types of battery packs have been made practical. A representative battery charger has an attachment section on the upper surface of the case to mount a battery pack in a detachable manner, and is provided with charging terminals exposed in the attachment section. External terminals on a battery pack attached to the attachment section connect with the charging terminals on the battery charger, and the battery charger outputs charging power from the charging terminals to charge the battery pack. (Refer to Japanese Laid-Open Patent Publication 2008-236882.)

### SUMMARY OF THE INVENTION

The battery charger cited in JP 2008-236882 is shown in FIG. 1. This battery charger is provided with a plurality of connecting terminals 93 disposed in an attachment section 92 for attaching a battery pack in a detachable manner. The connecting terminals 93 are a plurality of metal plates disposed in a parallel arrangement. The connecting terminals 93 are made up of positive and negative charging terminals 94 disposed at both ends of the column of connecting terminals 93, and a plurality of signal terminals 95 disposed between the charging terminals 94. In this battery charger, the probability of short circuiting the charging terminals 94 by contact with material such as a metal foreign object is reduced by disposing the positive and negative charging terminals 94 in a separated manner at both ends of the connecting terminals 93. However, as shown by the broken lines in FIG. 2, a rod-shaped metal foreign object 90 such as a nail 90A or a piece of metal wire 90B can span across and contact the charging terminals 94 at both ends of this connecting terminal 93 configuration. This results in the detrimental condition where the charging terminals 94 become short circuited.

The present invention was developed with the object of correcting this drawback. Thus, it is a primary object of the present invention to provide a battery charger that can effectively prevent short circuits due to material such as a metal foreign object contacting the charging terminals disposed on both sides of the attachment section by implementing an extremely simple structure.

The battery charger of the present invention charges a battery pack housing rechargeable batteries by attaching the battery pack 30 in a detachable manner on the battery charger. The battery charger is provided with a case 1 having an attachment section 2 where a battery pack 30 is attached in a detachable manner, and a plurality of connecting terminals 3 disposed in an exposed manner in the attachment section 2 to connect with external terminals 33 on the battery pack 30. The plurality of connecting terminals 3 is disposed in a plurality of rows. The connecting terminals 3 are provided with positive and negative charging terminals 4 disposed on both sides, and non-charging terminals 5 disposed between the charging terminals 4. Further, the non-charging terminals 5 are disposed in a manner projecting outward further than the charging terminals 4 on both sides. Here, “non-charging terminals disposed in a manner projecting outward further than the charging terminals on both sides” means that the edges at the ends of the non-charging terminals extend outward further than a straight-line joining the edges at the ends of the charging terminals on both sides.

The battery charger described above is characterized by an extremely simple structure that can effectively prevent short circuits due to material such as a metal foreign object contacting the charging terminals disposed on both sides of the attachment section. This is because the battery charger of the present invention has connecting terminals disposed in a plurality of rows and exposed from the attachment section, and the connecting terminals are configured with positive and negative charging terminals disposed on both sides and non-charging terminals disposed between the charging terminals. Further, the non-charging terminals protrude outward further than the charging terminals on both sides. In a battery charger with this structure, even if material such as a rod-shaped or flat-plate-shaped metal foreign object contacts the plurality of connecting terminals exposed from the attachment section, the outward protruding non-charging terminals prevent the foreign object from spanning across and contacting the positive and negative charging terminals disposed on both sides. Consequently, short circuits are prevented. As shown by the broken lines A-D in FIGS. 8 and 9, the non-charging terminals, which extend outward further than the charging terminals, preferentially contact the center region of a metal foreign object and prevent the end regions of that object from simultaneously contacting the charging terminals on both sides. Accordingly, the battery charger of the present invention with an extremely simple structure can effectively prevent the charging terminals disposed on both sides of the attachment section from being short circuited by material such as a metal foreign object.

In the battery charger of the present invention, the upper ends of the non-charging terminals 5 can protrude outward from the base 2A of the attachment section 2 further than the upper ends of the charging terminals 4. In this battery charger, even if material such as a rod-shaped or flat-plate-shaped metal foreign object contacts the top of the plurality of rows of connecting terminals exposed from the attachment section, short circuit of the positive and negative charging terminals disposed on both sides is effectively prevented by the protruding non-charging terminals.

In the battery charger of the present invention, a battery pack 30 is attached and detached by sliding it along the base 2A of the attachment section 2. Further, the front ends of the non-charging terminals 5 can protrude outward in a direction parallel to the battery pack 30 detachment sliding direction further than the front ends of the charging terminals 4. In this battery charger, a battery pack can be simply and easily attached in, and detached from a fixed position by sliding it along the base of the attachment section. Further, even if material such as a rod-shaped or flat-plate-shaped metal foreign object contacts the front end of the plurality of rows of connecting terminals exposed in the battery pack sliding direction, short circuit of the positive and negative charging terminals disposed on both sides is effectively prevented by the protruding non-charging terminals.

In the battery charger of the present invention, the plurality of connecting terminals 3 can have a flat-plate shape and can be disposed in parallel orientation. The flat-plate connecting terminals 3 can be disposed perpendicular to the base 2A of the attachment section 2 extending in a direction parallel to the battery pack 30 detachment sliding direction. In this battery charger, the connecting terminals are disposed in minimal area allowing ideal connection while having a flat-plate structure of utmost simplicity.

In the battery charger of the present invention, a plurality of non-charging terminals 5 can be disposed between the positive and negative charging terminals 4, and those non-charging terminals 5 can be used as signal terminals 5A. In this battery charger, various data communication can take place to share battery data between the battery charger and the battery pack and allow the battery pack batteries to be charged in an ideal manner.

The above and further objects of the present invention as well as the features thereof will become more apparent from the following detailed. description to be made in conjunction with the accompanying drawings.

### BRIEF DESCRIPTION OF THE DRAWINGS

FIG. 1 is an oblique view of a prior art battery charger;

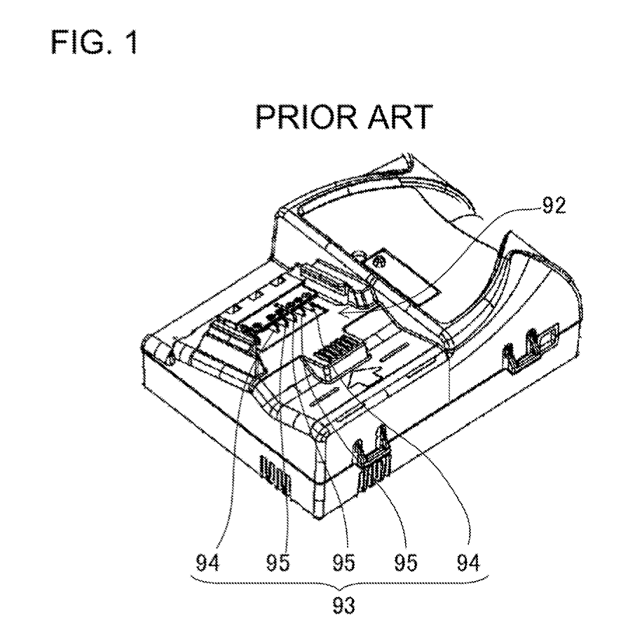

FIG. 2 is a plan view showing the positive and negative charging terminals of the battery charger shown in FIG. 1 short circuited by metal foreign objects;

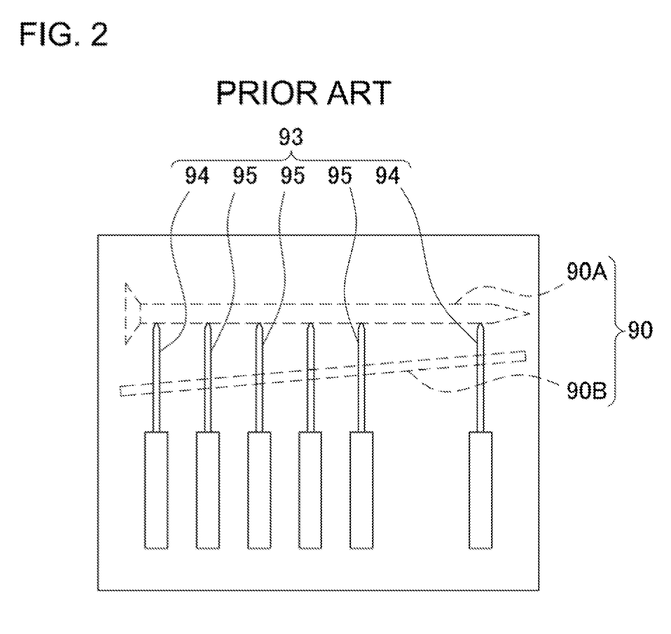

FIG. 3 is an oblique view of a battery charger for an embodiment of the present invention;

FIG. 4 is an oblique view showing attachment of a battery pack to the battery charger shown in FIG. 3;

FIG. 5 is a vertical cross-section showing a battery pack attached to the battery charger shown in FIG. 3;

FIG. 6 is an enlarged cross-section through the line VI-VI of FIG. 5 showing the attachment section of the battery charger shown in FIG. 3;

FIG. 7 is an enlarged plan view of the attachment section of the battery charger shown in FIG. 3;

FIG. 8 is an enlarged view showing the contact configuration of a metal foreign object on the connecting terminals shown in FIG. 6;

FIG. 9 is an enlarged view showing the contact configuration of a metal foreign object on the connecting terminals shown in FIG. 7;

FIG. 10 is a circuit diagram showing a battery pack connected to a battery charger for an embodiment of the present invention;

FIG. 11 is an oblique view from below of the battery pack shown in FIG. 4.

### DETAILED DESCRIPTION OF THE EMBODIMENT(S)

The following describes embodiments of the present invention based on the figures.

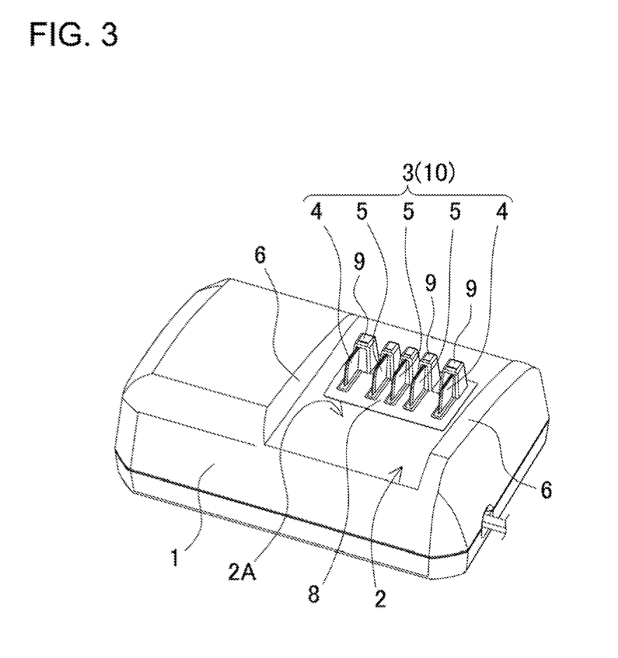

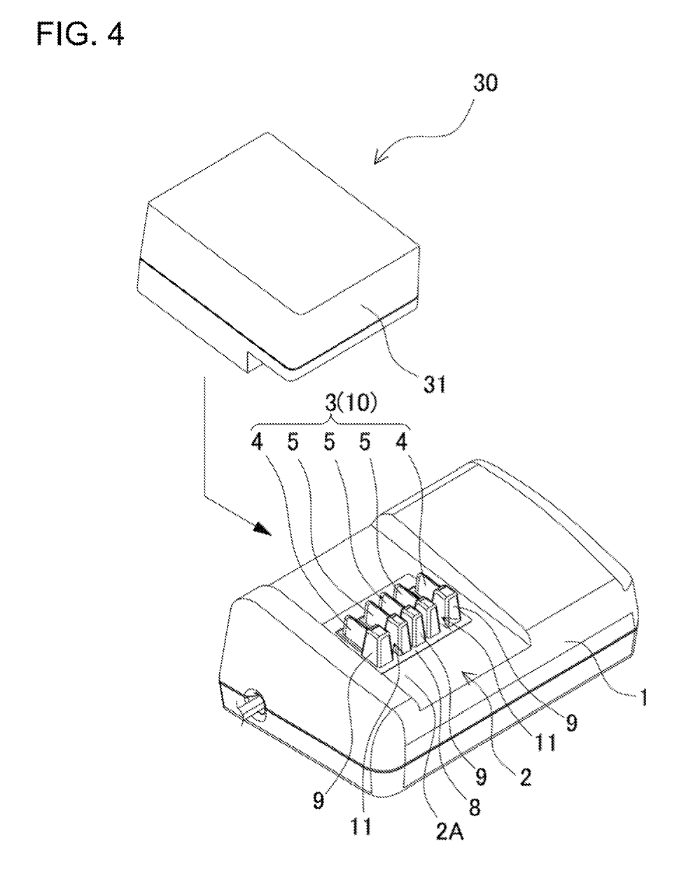

The battery charger of FIGS. 3-10 is provided with a case 1 having an attachment section 2 that allows a battery pack 30 housing batteries 39 that can be charged to be attached in a detachable manner, and a plurality of connecting terminals 3 disposed in an exposed manner in the attachment section 2 to connect with external terminals 33 on the battery pack 30. In addition, the battery charger has charging circuitry housed in the case 1 to charge the battery pack 30 attached in the attachment section 2.

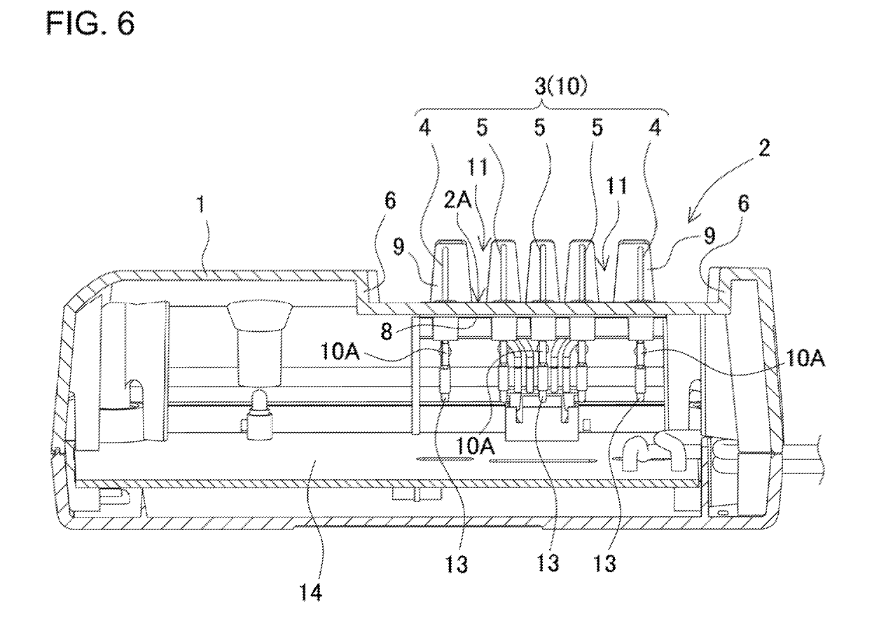

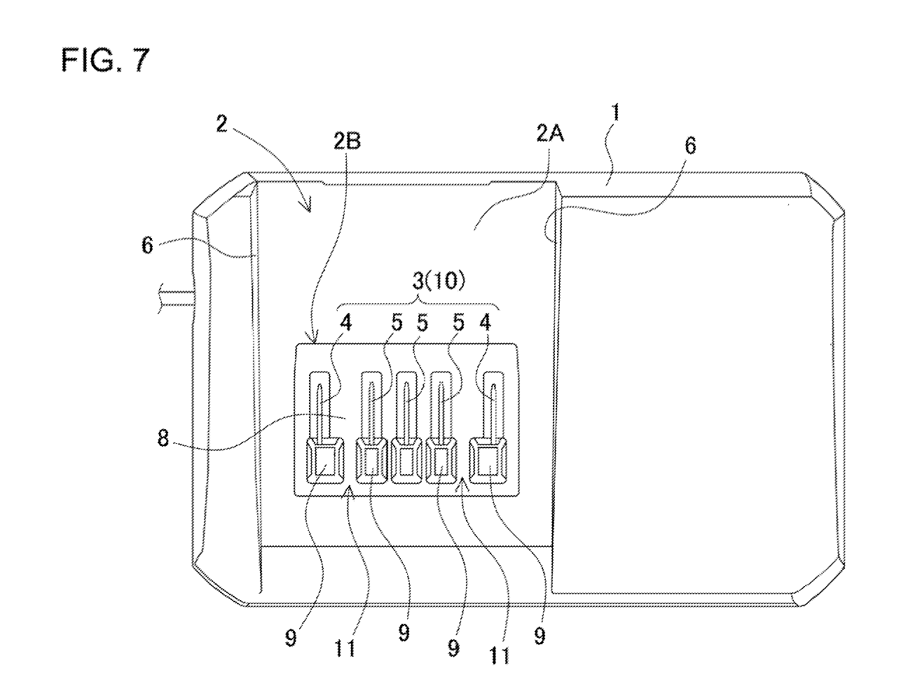

The case 1 is provided with an attachment section 2 on its upper surface allowing a battery pack 30 to be attached in a detachable manner. The battery charger of FIGS. 3 and 6 is provided with an attachment section 2 on one side (the right side in the figures) of the upper surface of the case 1. The attachment section 2 has a base 2A with side-walls 6 on both sides giving it an overall channel or groove-shape. The groove-shaped attachment section 2 is configured to attach and detach a battery pack 30 by sliding it along the groove. A battery pack 30 is slid along the base 2A of the attachment section 2 and is slid along the side-walls 6 on both sides to guide it into a fixed position in the attachment section 2. In the case 1 shown in FIG. 7, separation between the pair of side-walls 6 gradually becomes narrower in the battery pack 30 insertion direction. During battery pack 30 attachment in the attachment section 2, this configuration allows the insertion side of the battery pack 30 to be smoothly introduced into the attachment section 2 groove while allowing the fully inserted battery pack 30 to be reliably stopped in a fixed position.

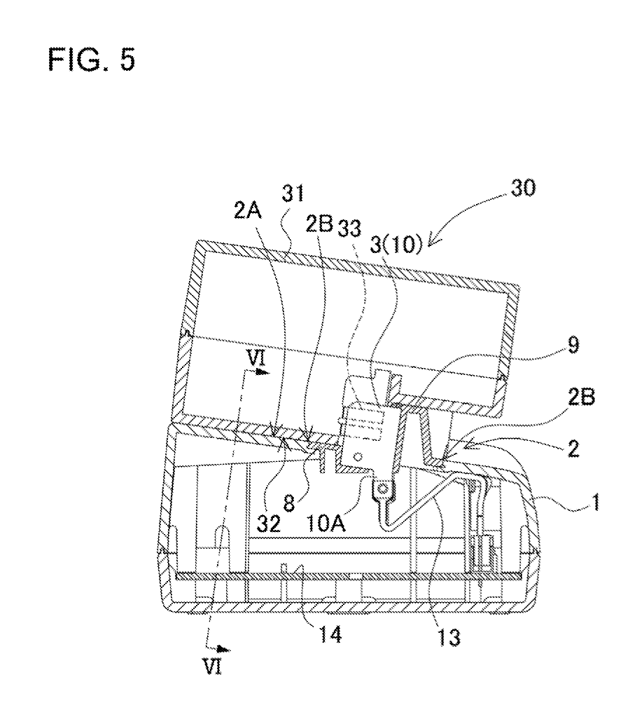

In addition, the case 1 of the figures has the base 2A of the attachment section 2 formed as an inclined surface. The base 2A of the attachment section 2 shown in FIG. 5 is formed with an incline that slopes downward in the battery pack 30 attachment direction. In an attachment section 2 with a downward sloping base 2, a battery pack 30 can be attached in a fixed position by sliding it downward along the base 2A, which is an inclined surface. In particular, when the battery pack 30 is being attached to the battery charger, the gravitational force acting on the battery pack 30 has a component in the direction along the inclined surface that acts to slide the battery pack 30 downward along the inclined surface. Consequently, even a heavy battery pack 30 can be easily attached in a fixed position in the attachment section 2, and the attached battery pack 30 can be stably retained in a fixed position in the attachment section 2.

Further, although not illustrated, the case side-walls in the attachment section can be provided with guide projections that protrude out from the inside surfaces of the attachment section side-walls and insure that the battery pack slides along the base of the attachment section in correct 5, orientation. Correspondingly, both sides of the battery pack casing can be provided with grooves that mate with the guide projections. When the battery pack is attached to the attachment section, the guide projections are inserted in the grooves established on both sides of the battery pack allowing the battery pack to be introduced into the attachment section with the proper orientation. For example, the guide projections can be formed in single-piece construction on the inside surfaces of opposing side-walls positioned in the upper part of the downward sloping attachment section at the end where the battery pack is inserted. The guide projections can be established in a manner extending in the battery pack attachment direction. A battery pack introduced into the attachment section can be slid along the guide projections, and the external terminals on the battery pack can make contact with attachment section connecting terminals in the proper orientation.

The attachment section 2 is provided with a plurality of protruding connecting terminals 3 that connect with external terminals 33 on a battery pack 30. These connecting terminals 3 connect with the external terminals 33 on a battery pack 30 attached in the attachment section 2 and supply charging power to the battery pack 30 or send and receive various signals to and from the battery pack 30. In the attachment section 2 of the figures, the plurality of connecting terminals 3 is disposed in the center region of the base 2A in a manner projecting out from the base 2A. The connecting terminals 3 are disposed side-by-side in a single column.

The connecting terminals 3 shown in the figures are flat metal plates 10 with essentially the same outline shape disposed in parallel orientation. The flat-plate connecting terminals 3 are disposed perpendicular to the base 2A of the attachment section 2 and are oriented in line with the battery pack 30 insertion direction. The metal plate 10 connecting terminals 3 are made from sheet-metal with superior conductivity such as nickel, copper, or copper alloy sheet-metal. However, the connecting terminals are not necessarily limited to a flat-plate-shape. The connecting terminals can be any of various shapes that can protrude from the inside of the attachment section and connect with the external terminals on a battery pack attached in the attachment section.

The connecting terminals 3 shown in FIG. 5 are metal plates 10 inserted in fixed positions in the attachment section 2. In the attachment section 2 of the figures, metal plates 10 are insertion molded in a connecting plate piece 8 formed from plastic as a separate piece. The connecting plate piece 8 with the embedded metal plates 10 is mounted in a connecting cavity 2B opened in the base 2A of the attachment section 2 to hold it in a fixed position in the attachment section 2. The connecting plate piece 8 is provided with a plurality of mounting projections 9 formed in single piece construction with the connecting plate piece 8 and projecting from its upper surface. The metal plates 10 are mounted on the mounting projections 9 in a manner protruding in the direction of battery pack 30 insertion. The metal plates 10 shown in FIG. 5 have an overall rectangular shape, their lower regions are embedded in the connecting plate piece 8, and their aft regions are embedded in the mounting projections 9. Specifically, two sides of each rectangular metal plate 10 are fixed in place by insertion molding in a mounting projection 9 and connecting plate piece 8. This structure allows the metal plate 10 connecting terminals 3 to be solidly attached in fixed positions in the attachment section 2. However, the metal plate connecting terminals can also be held in fixed positions by insertion molding only one side of each rectangular metal plate. Specifically, only the lower region of each metal plate can be embedded in the connecting plate piece, or only the aft region of each metal plate can be embedded in a mounting projection. Each metal plate 10 of the figures is provided with a connecting region 10A extending from its lower edge. The metal plates 10 are connected to a circuit board 14 housed inside the case 1 via lead-wires 13 connected to the connecting regions 10A of the metal plates 10.

The mounting projections 9 shown in FIGS. 3, 4, 6, and 7 are separated into a plurality of rows, and a metal plate 10 is embedded and mounted in each mounting projection 9. This structure allows foreign material ingress such as dust and water condensation to flow from the space 11 between adjacent mounting projections 9 down the inclined surface of the attachment section 2. Consequently, the plurality of connecting terminals 3 can consistently be maintained in a clean condition, and short circuits and corrosion due to dust and moisture can effectively be prevented. However, the mounting projections can also be formed as a single block with a plurality of connecting terminals embedded and held in that mounting block.

The connecting terminals 3 are made up of positive and negative charging terminals 4 for the purpose of charging batteries 39 housed in a battery pack 30, and non-charging terminals 5 that are signal terminals 5A for communicating battery information between the battery pack 30 and the battery charger. The battery charger of FIGS. 6-9 has five connecting terminals 3 arranged side-by-side in a single column. The five connecting terminals 3 consist of a pair of charging terminals 4 disposed on both sides, and three non-charging terminals 5 that are signal terminals 5A disposed between the charging terminals 4. However, the non-charging terminals are not necessarily restricted to three terminals, and two or fewer terminals as well as four or more non-charging terminals can also be provided.

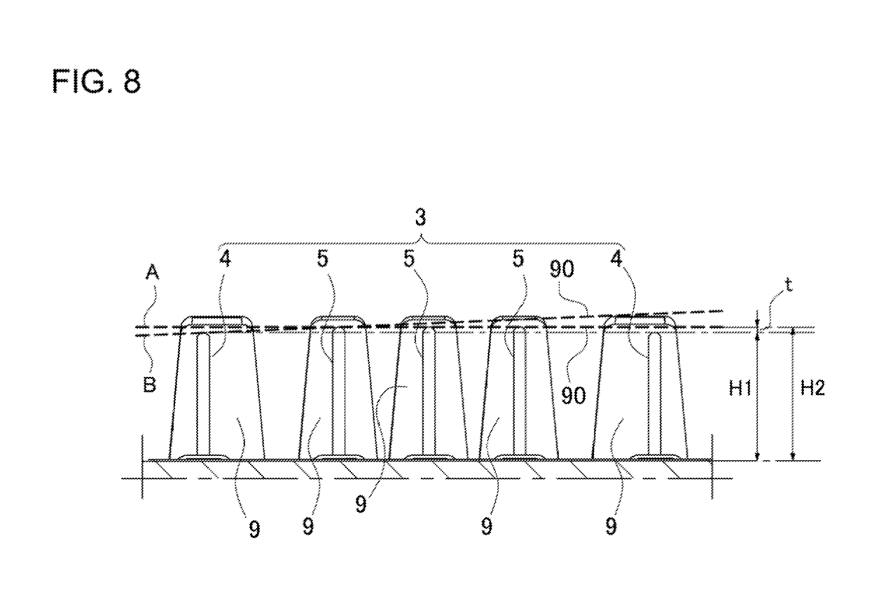

Further, the plurality of connecting terminals 3 has the non-charging terminals 5 disposed between the charging terminals 4 in a manner projecting outward further than the charging terminals 4 on both sides. Here, “non-charging terminals 5 disposed between the charging terminals 4 in a manner projecting outward further than the charging terminals 4 on both sides” means that the edges at the ends of the non-charging terminals 5 project out further than a straight-line joining the edges at the ends of the charging terminals 4 on both sides. The connecting terminals 3 shown in FIG. 8 have the upper edges of the non-charging terminals 5 set at a height (H2) with respect to the base 2A of the attachment section 2, which is greater than the height (H1) of the upper edges of the charging terminals 4. Specifically, the upper edges of the non-charging terminals 5 are made to project out further than the upper edges of the charging terminals 4. As shown by the broken line A in FIG. 8, when a metal foreign object 90 contacts the top of this connecting terminal 3 configuration, the non-charging terminals 5 preferentially contact the central region of the metal foreign object 90 and prevent the ends of the metal foreign object 90 from contacting the charging terminals 4 on both sides. In addition, as shown by the broken line B in FIG. 8, even when the metal foreign object 90 is slanted to contact the charging terminal 4 on one side (left side of the figure), one end of the metal foreign object 90 contacts the charging terminal 4 and adjacent non-charging terminal 5 on one side (left side of the figure) preventing the other end of the metal foreign object 90 from contacting the charging terminal 5 on the opposite side (right side of the figure). This structure can effectively prevent short circuit between the pair of charging terminals 4 when a metal foreign object 90 falls on top and contacts the connecting terminals 3. The amount of protrusion [t] of the upper edges of the non-charging terminals 5 from a straight-line joining the upper edges of the charging terminals 4 on both sides is set at 0.3 mm to 5 mm, preferably 0.4 mm to 2 mm, and more preferably 0.5 mm to 2 mm.

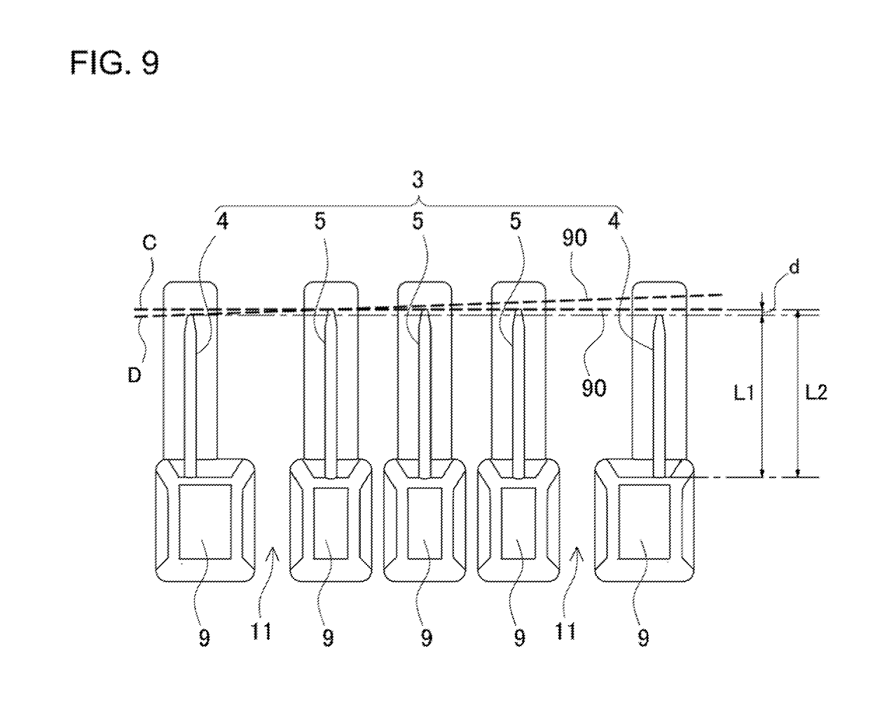

Further, the connecting terminals 3 shown in FIG. 9 have the front edges of the non-charging terminals 5 projecting outward in the battery pack 30 detachment direction further than the front edges of the charging terminals 4. In the battery charger of the figures, the front edges of the mounting projections 9 are disposed in a straight-line. Accordingly, the length (L2) of the non-charging terminals 5 extending out from the mounting projections 9 is made longer than the length (L1) of the charging terminals 4 extending out from the mounting projections 9. Specifically, the front edges of the non-charging terminals 5 are made to project out further than the front edges of the charging terminals 4. As shown by the broken line C in FIG. 9, when a metal foreign object 90 contacts the front end of this connecting terminal 3 configuration, the non-charging terminals 5 preferentially contact the central region of the metal foreign object 90 and prevent the ends of the metal foreign object 90 from contacting the charging terminals 4 on both sides. In addition, as shown by the broken line D in FIG. 9, even when the metal foreign object 90 is slanted to contact the charging terminal 4 on one side (left side of the figure), one end of the metal foreign object 90 contacts the charging terminal 4 and adjacent non-charging terminal 5 on one side (left side of the figure) preventing the other end of the metal foreign object 90 from contacting the charging terminal 5 on the opposite side (right side of the figure). This structure can effectively prevent short circuit between the pair of charging terminals 4 when a metal foreign object 90 contacts the front end of the connecting terminals 3. For example, this structure can effectively prevent short circuit between the pair of charging terminals 4 when a metal foreign object 90 slides down the inclined attachment surface and contacts the front end of the connecting terminals 3. The amount of protrusion [d] of the front edges of the non-charging terminals 5 from a straight-line joining the front edges of the charging terminals 4 on both sides is set at 0.3 mm to 5 mm, preferably 0.4 mm to 2 mm, and more preferably 0.5 mm to 2 mm.

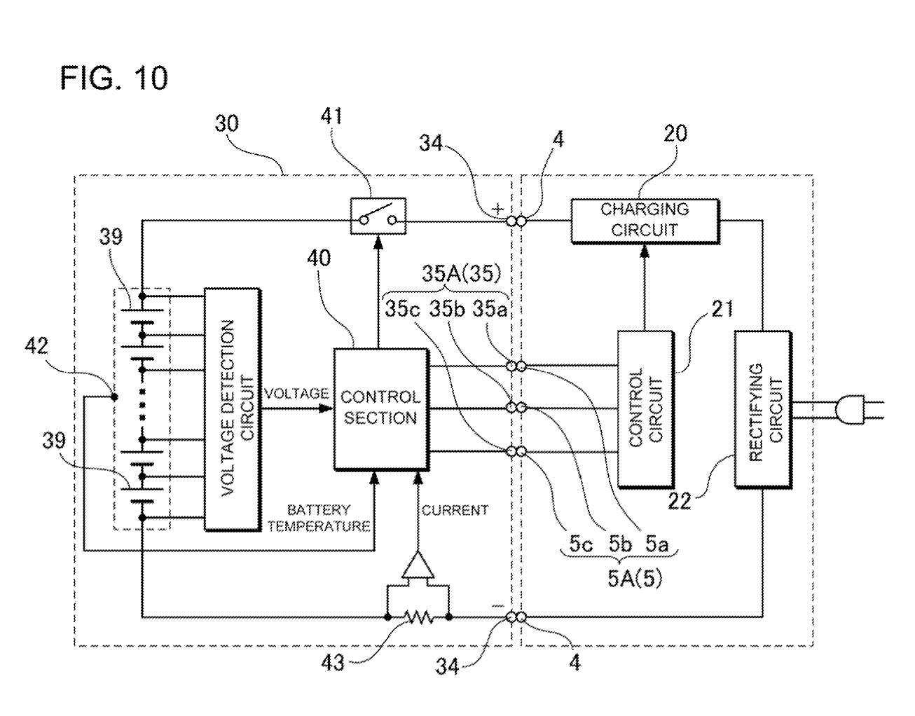

The positive and negative charging terminals 4 disposed on both sides of the connecting terminals 3 connect to the positive and negative charging and discharging terminals 34 of a battery pack 30 attached in the attachment section 2 to supply charging power to the battery pack 30. As shown in the circuit diagram of FIG. 10, the positive charging terminal 4 is connected to a charging circuit 20 that supplies power to the battery pack 30 and charges the batteries 39 inside the battery pack 30. In the battery charger of the figure, alternating current (AC) from a commercial power source (not illustrated) is converted to direct current (DC) by a rectifying circuit 22, the DC voltage is converted to a voltage appropriate for battery charging by the charging circuit 20, and the resulting power is output from the charging terminals 4. For example, the charging circuit 20 regulates charging voltage and current to optimum values for charging the battery pack 30 by adjusting the ON and OFF duty cycle of a switching device (not illustrated) connected between the output-side of the rectifying circuit 22 and the positive charging terminal 4.

The non-charging terminals 5 disposed between the pair of charging terminals 4 are signal terminals 5A. The connecting terminals 3 shown in the figures are provided with three signal terminals 5A. The signal terminals 5A are allocated as an error signal terminal 5a where battery pack 30 internal battery 39 error signals are input, a temperature signal terminal 5b where battery pack 30 internal battery 39 temperature signals are input, and a battery pack discrimination signal terminal 5c where signals to determine the type of batteries 39 inside the battery pack 30 are input. However, the signal terminals can also be designated for communicating other signals. For example, signal terminals can also be allocated for transmitting the state of battery charge and various other battery data.

When an error signal is input to the error signal terminal 5a, a control circuit 21 in the battery charger judges that a battery pack 30 abnormality has occurred and switches the charging circuit 20 OFF to stop charging. In addition, the control circuit 21 detects the temperature of the batteries 39 housed in the battery pack 30 from temperature signals input to the temperature signal terminal 5b. When battery temperature rises above a maximum temperature, the control circuit 21 cuts-off charging current to suspend charging or it reduces charging current to lower the battery temperature. When battery temperature drops below a set temperature, charging with normal charging current is resumed.

Further, the control circuit 21 determines the optimum voltage and current values for charging a battery pack 30 from battery discrimination signals input to the discrimination signal terminal 5c, and accordingly changes the charging voltage and current output from the charging terminals 4. When the battery pack 30 is attached to the battery charger, a discrimination signal is output from the battery pack 30 control section 40 (FIG. 10) and received by the battery charger control circuit 21. The control circuit 21 determines the battery pack 30 type from the input battery discrimination signal, and controls the charging circuit 20 to charge the battery pack 30 with the optimum charging voltage and current values. This battery charger switches charging voltage and current to values most appropriate for the attached battery pack 30 as determined from the battery discrimination signal input from the battery pack 30. Therefore, a plurality of battery pack types having different voltages can be charged with a single battery charger. However, switching the output voltage is not a necessary requirement, and the battery charger can also charge battery packs with a set output voltage.

The battery pack 30 attaches in a detachable manner to electrically driven machinery such as electric power tools to supply power to those devices. Although not illustrated, the battery pack 30 houses a plurality of secondary battery cells that can be charged (rechargeable batteries). The rechargeable batteries housed in the battery pack are lithium ion batteries. However, any other batteries that can be charged such as nickel hydride batteries, nickel cadmium batteries, and polymer batteries can also be used. Although not illustrated, the plurality of rechargeable batteries is connected with a plurality of batteries in series to increase output voltage and a plurality of batteries in parallel to increase output current. For example, in a battery pack 30 housing lithium ion batteries, sixteen batteries can be connected as four parallel groups of four series-connected batteries for an output voltage of 14.4V. Or, twenty lithium ion batteries can be connected as four parallel groups of five series-connected batteries for an output voltage of 18V. However, the number of batteries and their connection configuration in the battery pack is not specified or limited. The number of rechargeable batteries and the battery pack output voltage can be set by various design configurations suited to the type and application of the electrical equipment that uses the battery pack.

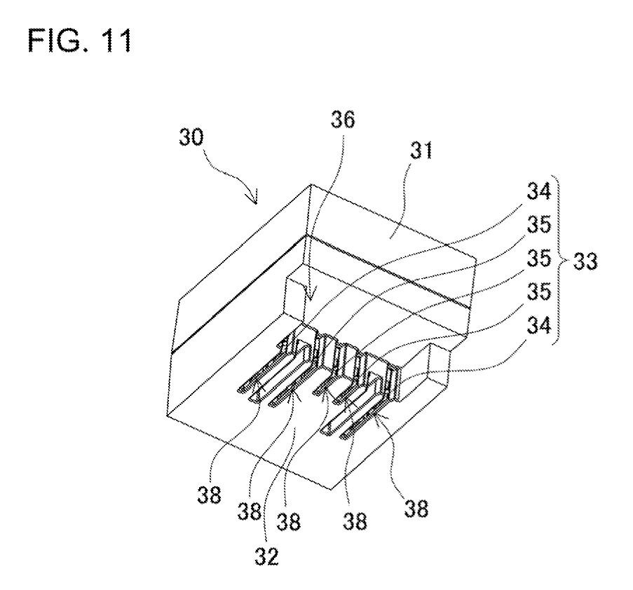

Further, the battery pack 30 of FIGS. 10 and 11 is provided with a plurality of external terminals 33 that connect to the plurality of connecting terminals 3 disposed in the battery charger attachment section 2. The plurality of external terminals 33 is disposed on an attachment surface 32, which is the bottom surface of the battery pack 30 that faces the base 2A of the attachment section 2 when the battery pack 30 is attached in the battery charger attachment section 2. The battery pack 30 of the figures is provided with a stepped cavity 36 in the bottom surface of the casing 31. The mounting projections 9 that protrude outward from the battery charger attachment section 2 fit into the stepped cavity 36 to guide the battery pack 30 into a fixed position in the attachment section 2.

Further, the battery pack 30 of FIG. 11 is provided with a plurality of parallel disposed lengthwise grooves 38 in the attachment surface 32, and flexible contacts, which are the external terminals 33, are disposed inside those lengthwise grooves 38. The flexible contact external terminals 33 make electrical connection with flat-plate connecting terminals 3 inserted into the lengthwise grooves 38 by resiliently applying pressure on both sides of the connecting terminals 3. The external terminals 33 of the figures (FIGS. 10 and 11) are provided with charging and discharging terminals 34 disposed on both sides, and communication terminals 35 disposed between the charging and discharging terminals 34. The charging and discharging terminals 34 on both sides connect with the charging terminals 4 on the battery charger, and the centrally located communication terminals 35 connect with the signal terminals 5A, which are the non-charging terminals 5 on the battery charger. The communication terminals 35 are a plurality of signal terminals that serve to transmit data, which are related to the plurality of internally housed rechargeable batteries 39, outside the battery pack 30. The communication terminals 35 shown in FIG. 10 are established as an error signal terminal 35a that outputs battery pack 30 internal battery 39 error signals, a temperature signal terminal 35b that outputs battery 39 temperature signals, and a battery pack discrimination signal terminal 35c that outputs signals to distinguish the type of batteries 39 housed in the battery pack 30.

Further, although not illustrated, the battery pack can be provided with a retaining projection that holds the battery pack in a fixed position when it is attached in the attachment section. The retaining projection can be established in a retractable manner at the end of the bottom surface of the casing, and the end of the retaining projection can be provided with a latching hook. The retaining projection can be spring-loaded downward via a mechanism such as a coil-less spring. When the battery pack is attached to the battery charger attachment section, the latching hook at the end of the retaining projection can latch into a latching cavity provided in the attachment section and hold the battery pack rigidly in the battery charger. The battery pack can be separated from the battery charger by finger-pressure applied to release the latching hook from the latched state and raise the retaining projection.

In addition, the battery pack 30 shown in FIG. 10 is provided with a charging and discharging switch 41 connected in series with the rechargeable batteries 39, and a control section 40 that controls the charging and discharging switch 41 OFF when a battery 39 abnormality is detected. The charging and discharging switch 41 is switched from ON to OFF when the batteries 39 become fully charged to prevent over-charging. The charging and discharging switch 41 is also switched OFF when the batteries 39 become completely discharged to prevent over-discharging.

The control section 40 detects current flowing through the batteries 39 and battery voltage to compute the remaining battery capacity. A current detection resistor 43 connected in series with the batteries 39 is provided to detect the battery current. Voltage is detected on both sides of the current detection resistor 43 to determine the charging current and discharging current flowing through the batteries 39. In addition, when the control section 40 detects excessive battery current or abnormally high battery temperature, it switches the charging and discharging switch 41 OFF to cut-off current flow through the batteries 39. When the control section 40 detects an internal battery abnormality, it issues an error signal to the outside from the communication terminals 35.

Further, the battery pack of FIG. 10 is provided with a temperature sensor 42 to detect the battery temperature. The temperature sensor 42 is a thermistor disposed in close proximity to, and thermally connected to the batteries 39. The temperature sensor 42 changes its electrical resistance corresponding to the temperature of the batteries 39 to detect battery temperature. When the battery temperature detected by the temperature sensor 42 rises above a set temperature, the control section 40 switches the charging and discharging switch 41 OFF to suspend charging or discharging. The control section 40 also outputs data from the communication terminals 35 indicating an abnormally high battery temperature.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2010-017,499 filed in Japan on Jan. 28, 2010, the content of which is incorporated herein by reference.

What is claimed is:

1. A battery charger for charging a battery pack attached in a detachable manner and housing rechargeable batteries, the battery charger comprising:
a case having an attachment section that allows the battery pack to be attached in a detachable manner; and
a plurality of connecting terminals disposed in an exposed manner in the attachment section that connects with external terminals on the battery pack, wherein the plurality of connecting terminals is disposed in a plurality of rows; the connecting terminals are provided with positive and negative charging terminals disposed on both sides, and non-charging terminals disposed between the charging terminals, and
wherein the non-charging terminals are disposed in a manner projecting outward further than the charging terminals on both sides.

2. The battery charger as cited in claim 1 wherein the upper ends of the non-charging terminals protrude outward from the base of the attachment section further than the upper ends of the charging terminals.

3. The battery charger as cited in claim 1 wherein the battery pack is attached and detached by sliding it along the base of the attachment section; and the front ends of the non-charging terminals protrude outward in a direction parallel to the battery pack detachment sliding direction further than the front ends of the charging terminals.

4. The battery charger as cited in claim 1 wherein all of the plurality of connecting terminals have flat-plate shapes disposed in parallel orientation; and the flat-plate connecting terminals are disposed perpendicular to the base of the attachment section extending in a direction parallel to the battery pack detachment sliding direction.

5. The battery charger as cited in claim 1 wherein a plurality of non-charging terminals is disposed between the positive and negative charging terminals, and those non-charging terminals are signal terminals.

6. The battery charger as cited in claim 1 wherein the attachment section is provided on the upper surface of the case to attach the battery pack in a detachable manner.

7. The battery charger as cited in claim 3 wherein the attachment section has a groove-shape and the groove-shaped attachment section is configured to attach and detach the battery pack by sliding it in the groove.

8. The battery charger as cited in claim 1 wherein the connecting terminals are disposed side-by-side in a single column.

9. The battery charger as cited in claim 1 wherein the connecting terminals are metal plates embedded in fixed positions in the attachment section.

10. The battery charger as cited in claim 9 wherein a connecting plate piece with embedded metal plates is formed from plastic as a separate piece, and the connecting plate piece with insertion molded metal plates is mounted in the attachment section.

11. The battery charger as cited in claim 10 wherein the connecting plate piece is provided with a plurality of mounting projections formed in single piece construction with the connecting plate piece and projecting from its upper surface; the metal plates are mounted on the mounting projections in a manner protruding in the direction of battery pack insertion; and the metal plates have an overall rectangular shape, their lower regions are embedded in the connecting plate piece, and their aft regions are embedded in the mounting projections thereby embedding and holding two sides of each rectangular metal plate in a mounting projection and in the connecting plate piece.

12. The battery charger as cited in claim 11 wherein the mounting projections are separated into a plurality of rows, and a metal plate is embedded and mounted in each mounting projection.

13. The battery charger as cited in claim 2 wherein the amount of protrusion [t] of the upper edges of the non-charging terminals from a straight-line joining the upper edges of the charging terminals on both sides is 0.3 mm to 5 mm.

14. The battery charger as cited in claim 3 wherein the amount of protrusion [d] of the front edges of the non-charging terminals from a straight-line joining the front edges of the charging terminals on both sides is 0.3 mm to 5 mm.

15. The battery charger as cited in claim 1 wherein the battery pack that is charged is a battery pack that attaches in a detachable manner to electrically driven machinery such as an electric power tool.
